(19) United States
(12) Patent Application Publication
(10) Pub. No.: US 2018/0323416 A1
(43) Pub. Date: Nov. 8, 2018

(54) METHOD FOR PRODUCING AN ELECTRODE COMPOSITE

(71) Applicant: ROBERT BOSCH GMBH, Stuttgart (DE)

(72) Inventors: Christoph SCHLUND, Bamberg (DE); Juergen HEROLD, Weismain (DE); Silvan POLLER, Neisseaue Ot Kaltwasser (DE); Thomas KRETSCHMAR, Zapfendorf (DE)

(21) Appl. No.: 15/763,692

(22) PCT Filed: Sep. 9, 2016
(86) PCT No.: PCT/EP2016/071295

§ 371 Date: Mar. 27, 2018

(30) Foreign Application Priority Data
Sep. 28, 2015 (DE) 10 2015 218 533.8

(51) Int. Cl. H01M 2/16; H01M 10/0585; H01M 10/04; H01M 2/18; H01M 10/0525

(52) U.S. Cl. CPC H01M 2/1673; H01M 10/0585; H01M 10/0404; H01M 2220/20; H01M 10/0525; H01M 10/0413; H01M 2300/0094; H01M 2/18

(57) ABSTRACT

The invention relates to a method for producing an electrode composite (23) of a battery cell, in particular of a lithium-ion battery cell, comprising at least one first electrode (1) having an in particular strip-type first electrode film (1a), at least one second electrode (2), and at least one in particular strip-type separator film (5a, 5b), wherein the in particular strip-type first electrode film (1a) is trimmed to fit on a first side, from where the first electrode film (1a) can be contacted in the finished battery cell so that at least one first contact tab (1b) is exposed.

### BACKGROUND OF THE INVENTION

The present invention relates to a method for producing an electrode composite of a battery cell and also to a battery cell and to a battery.

A battery cell is an electrochemical energy store which converts the stored chemical energy into electrical energy by virtue of an electrochemical reaction when it discharges. New battery systems, which are subject to very stringent requirements in respect of reliability, safety, performance and service life, will be used in the future both in stationary applications such as wind turbines, in motor vehicles which are configured as hybrid or electric motor vehicles, and also in electronic appliances. Owing to their high energy density, lithium-ion batteries in particular are used as energy stores for electrically driven motor vehicles.

Various methods are known for producing electrode composites. In a first method, a positive electrode and a negative electrode and also a separator in a respectively suitable format are trimmed and then stacked one on the other, wherein the electrodes are separated from one another by a separator in each case. The electrodes and the separator are held and put into position separately from one another in this case.

US 2014/0373343 describes a method for producing an electrode composite, comprising a first electrode, a first separator, a second electrode and a second separator, wherein the electrodes and separators are alternately stacked one on the other. The electrode foils are trimmed on two opposite sides beforehand.

WO2012/020480 describes a method for producing an electrode composite, wherein the positive electrode is laminated between two separator films in each case.

### SUMMARY OF THE INVENTION

The invention provides a method for producing an electrode composite of a battery cell, in particular of a lithium-ion battery cell, comprising at least one first electrode having an, in particular strip-like, first electrode foil, at least one second electrode and at least one separator film, wherein the first electrode foil is trimmed on a first side from which contact can be made with the first electrode foil in the finished battery cell, so that at least one first contact lug is exposed, and also provides a battery cell and a battery which is produced in accordance with said method.

The term ‘strip-like’ is intended to be understood to mean that the respective film/foil is, for example, a long, sheet-like film/foil as can be purchased, for example, from materials suppliers.

The, in particular strip-like, first electrode foil is trimmed on a first side from which contact can be made with the first electrode foil in the finished battery cell, so that at least one first contact lug is exposed. In this case, it is advantageous that the contact lug does not first have to be produced in a separate working step and then adhesively bonded or welded and therefore no weld seam or no adhesive bead is produced either. The production of the contact lug is firstly simplified and secondly accelerated by means of the proposed process. Furthermore, particles, which are produced during the welding process for example, are avoided.

The proposed method is simple and quick and has a high level of productivity, as a result of which it is suitable for series production. Electrode foils can be stacked at a stacking rate of above 10 Hz using a system of said kind.

Further advantageous embodiments of the present battery cell can be gathered from the dependent claims.

In a particularly advantageous embodiment, the, in particular strip-like, first electrode foil is trimmed, in particular exclusively, on the first side, before the first electrode, the separator films and the second electrode are stacked one on the other. In this case, it is advantageous that the first electrode foil has to be trimmed only on one side before a stacking operation, as a result of which time and working steps are saved. Therefore, the entire process runs more rapidly and more efficiently. A further result of the first electrode foil being trimmed only on a first side is that fewer particles are produced in comparison to cutting an electrode foil on several sides.

In one advantageous embodiment, for the purpose of producing a first electrode, an, in particular strip-like, first electrode foil is coated with a first active material, and, for the purpose of producing a second electrode, an, in particular strip-like, second electrode foil is coated with a second active material. In this case, it is advantageous that lithium ions can be stored in and removed from the active materials during the charging and discharging processes and therefore effective operation of the battery cell is ensured. Furthermore, it is advantageous when, in one embodiment, the coating with active material takes place in particular leaving free the region of the contact lug of the respective electrode since the contact lugs serve merely for electrical connection and therefore reliable electrical connection can be ensured without, for example, the battery cell being damaged or a short circuit occurring.

Furthermore, it is particularly advantageous when the electrode foils are coated with active material on both sides. In this way, no space is lost in the battery cell, and a considerably higher energy density of the battery cell is achieved in comparison to coating of the electrode foils on one side. In order to provide the same quantity of active material in the battery cell, two electrode foils would then have to be accommodated in the battery cell if they were coated on one side.

In one advantageous embodiment, the, in particular strip-like, second electrode foil is trimmed, in particular, on all sides, so that the second electrode and the contact lug of said second electrode are exposed. Electrical contact can be made with the electrode foil by means of the contact lug. The electrode has the necessary size dimensions for the following steps owing to the trimming. It is particularly advantageous when the second electrode foil is trimmed before the first electrode, the separator film and the second electrode are stacked one on the other since the trimmed electrode foil then only further has to be placed onto the respective other components of the electrode composite.

In one particularly advantageous embodiment, the second electrode is inserted between two, in particular strip-like, separator films and the two separator films are connected to one another at least partially in regions which project beyond the second electrode, in particular on all sides, so that a first stack arrangement is produced. In this case, it is advantageous that the second electrode, in particular the cathode, cannot slip as a result and is therefore exactly positioned. On account of it not being possible for the second electrode, in particular the cathode, to slip and therefore said second electrode being surrounded by the separator films on all sides, the stack arrangement provides a high degree of security, for example against slipping, which can otherwise result in, for example, losses in capacitance, damage or even a short circuit. In addition, connecting the two separator films to one another constitutes a simple and cost-effective working step.

In a further advantageous embodiment, the two separator films are connected to one another by lamination, thermal contact welding, adhesive bonding or perforation. The advantage of lamination is that a water-tight, oxygen-protected and high-strength connection results. However, adhesive bonding methods are simple, time-saving and cost-effective. The components to be adhesively bonded are not subjected to high temperatures, and therefore these components are not damaged. The advantage of thermal contact welding is that the processing time is very short and the thermal welding technique is more favorable than other welding methods since only a few specific tools are required. As a result, this constitutes a rapid method which is easy to manage.

A further embodiment provides that the, in particular strip-like, first electrode foil and the first stack arrangement are placed one above the other in such a way that the first contact lug of the first electrode and the second contact lug of the second electrode are spatially offset in relation to one another. As a result, contact between the first contact lug and the second contact lug is precluded, so that short circuits are avoided for example. In addition, it is advantageous in this case that stacking of this kind is very quick and simple.

In a further advantageous embodiment, the, in particular strip-like, first electrode foil and the, in particular strip-like, separator films of the electrode composite are trimmed in regions next to the second electrode and/or between two second electrodes, in particular after the first electrode foil and the first stack arrangement are stacked one on the other. This method step can be performed very quickly and in addition is very economical since no material loss occurs here, for example in series production when one finished electrode composite is separated after the other. In order to be able to reliably execute this step, the second electrode foil was trimmed, in particular on all sides, beforehand, so that it has smaller dimensions than the first electrode foil. If the second electrode foil had the same dimensions as the first electrode foil, it would be possible to separate the electrode foils only by one separator film after the trimming step and said electrode foils could come into contact even with a slight shift in the separator film, this in turn potentially leading to a short circuit. In addition, the step of connecting the two separator films between which the second electrode foil is arranged would then not be possible either. The step of connecting the separator films also serves for providing safety. In this way, it is not possible for the second electrode foil to slip, so that contact cannot be made between the first electrode foil and the second electrode foil.

In one advantageous embodiment, the electrode foils and/or the separator films are trimmed by means of a laser, a blade or a stamping tool. Precise cut edges are obtained without the formation of dust by means of laser cutting. In addition, laser cutting has only a slight thermal influence on the material, so that there is no distortion of the material. A cutting process using a blade has the advantage that a blade is available in a cost-effective manner and the cutting process is quick and simple. However, stamping is a rapid and energy-saving method. Frequent machine retrofitting times are dispensed with and various forms can be produced.

Furthermore, a battery cell, in particular a pouch cell, comprising a stacked electrode composite is advantageous, wherein the first electrode is an anode, and the, in particular strip-like, first electrode foil comprises, in particular, a copper foil, and wherein the second electrode is a cathode, and the, in particular strip-like, second electrode foil comprises, in particular, an aluminum foil. Aluminum has the advantage that it is lightweight and cost-effective and in addition is available in large quantities. However, copper is advantageous in respect of its corrosion resistance, this being accompanied by a long service life, amongst other things. In addition, copper is easy to process and can be deformed in an optimum manner even at low temperatures.

In a further advantageous embodiment, the separator film has larger dimensions than the first electrode and than the second electrode on that side on which the first contact lug of the first electrode and/or the second contact lug of the second electrode are/is located. However, in this case, the contact lugs of the first and/or of the second electrode project beyond the separator film. In this case, it is advantageous that as high a degree of safety as possible is therefore ensured since the electrodes are not in contact in this way and therefore damage to or even short circuits of the battery cell is/are avoided.

Furthermore, in one embodiment, it is particularly advantageous when the first electrode has larger dimensions than the second electrode. In this case, it is advantageous that production as described above is possible. In this way, the first electrode can be cut on two sides at the same time as the separator film, as a result of which working time and costs are saved.

In a further embodiment, it is provided that the separator film comprises a polyethylene and/or a polypropylene. Polyolefins, in particular polyethylene and polypropylene, are simultaneously robust and flexible, have a high degree of mechanical and chemical stability and in addition can be welded. Polyethylene has, for example, a high viscosity, a low level of water absorption and steam permeability, and also a high resistance to chemicals and, in addition, it is easy to process and is cost-effective. Polypropylene has a low level of water absorption, is chemically resistant, electrically insulating and also easy to process and cost-effective.

Furthermore, a battery which comprises a battery cell as described above is advantageous.

### BRIEF DESCRIPTION OF THE DRAWINGS

Embodiments of the present invention are illustrated in the drawing and explained in greater detail in the following description of the figures. In the drawing:

FIG. 1: is a schematic illustration of a method according to the invention for producing an electrode composite of a battery cell,

FIG. 2: is a schematic illustration of the step of trimming a first electrode foil on a first side in accordance with the method according to the invention illustrated in FIG. 1,

FIG. 3: is a schematic illustration of the step of trimming and fabricating a second electrode foil in accordance with the method according to the invention illustrated in FIG. 1,

FIG. 4: is a schematic illustration of the step of producing a first stack arrangement in accordance with the method according to the invention illustrated in FIG. 1,

FIG. 5a: is a schematic illustration of a plan view of the step of stacking the first electrode and the first stack arrangement one on the other and of steps for completing a stacked electrode composite in accordance with the method according to the invention,

FIG. 5b: is a schematic side view of the step of stacking the first electrode and the first stack arrangement one on the other and of steps for completing a stacked electrode composite in accordance with the method according to the invention, and

FIG. 6: is a schematic illustration of the size dimensions of a first electrode, the separator films and also a second electrode of a battery cell according to the invention.

### DETAILED DESCRIPTION

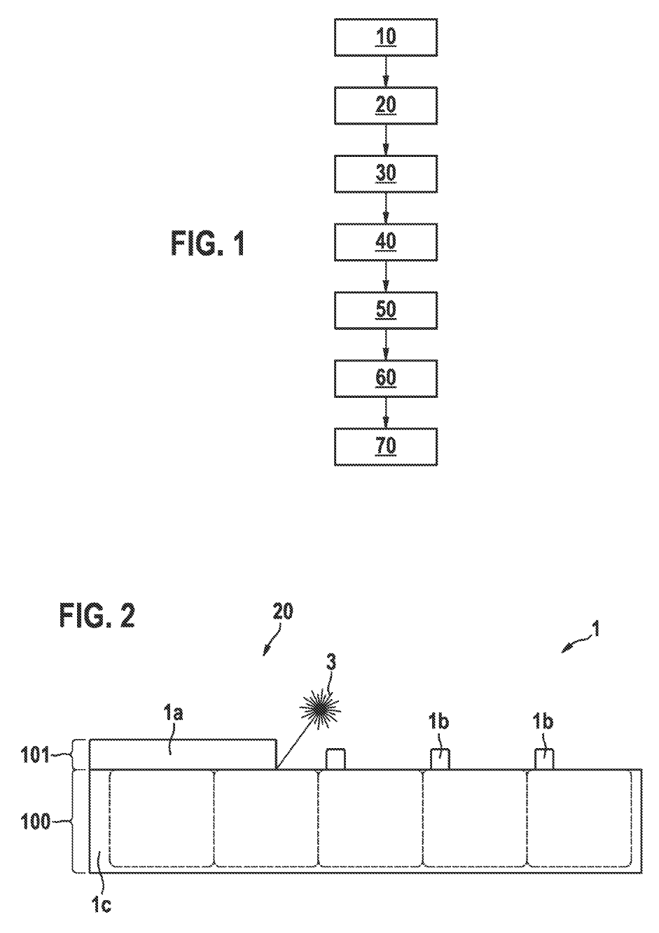

FIG. 1 illustrates a possible sequence of a method according to the invention in seven method steps. In a first step 10, the, in particular strip-like, first electrode foil and the, in particular strip-like, second electrode foil are coated, for example on both sides, with a first active material and, respectively, a second active material. As an alternative, the electrode foils are coated with active material only on one side. A first electrode is, for example, an anode, and the, in particular strip-like, first electrode foil comprises, for example, a copper foil which is coated with a graphite, in particular a natural graphite or a synthetic graphite, a carbon, a silicon or a composite of these substances, for example in connection with a polymeric binder. A second electrode is, for example, a cathode and the, in particular strip-like, second electrode foil comprises, for example, an aluminum foil which is coated, in particular, with a lithium transition-metal oxide, for example with LiNiₓMn_{y}Co_{z}O₂, or an over-lithiated lithium transition-metal oxide, for example with LiNiₓMn_{y}Co_{z}O₂*Li₂MnO₃, or another suitable lithium compound which comprises, for example, lithium ions, other metal ions and oxygen, or a lithium transition-metal phosphate, such as LiFePO₄ for example. In particular, regions of a first contact lug of the first electrode foil and of a second contact lug of the second electrode foil are left out during coating.

In a second step 20, which is illustrated in detail in FIG. 2, the, in particular strip-like, first electrode foil 1a is trimmed on a first side from which contact can be made with the first electrode 1 in the finished battery cell. At least one first contact lug 1b by means of which electrical contact can be made with the first electrode 1 is left standing in this case. In FIG. 2, the first electrode foil 1a is coated with a first active material 1c in a first region 100 of the first electrode foil 1a and is free of active material 1c in a second region 101 of the first electrode foil 1a. Only the first contact lugs 1b remain standing from the uncoated second region 101 of the first electrode foil 1a after the trimming operation. The first electrode foil 1a is trimmed, for example, by means of a laser 3.

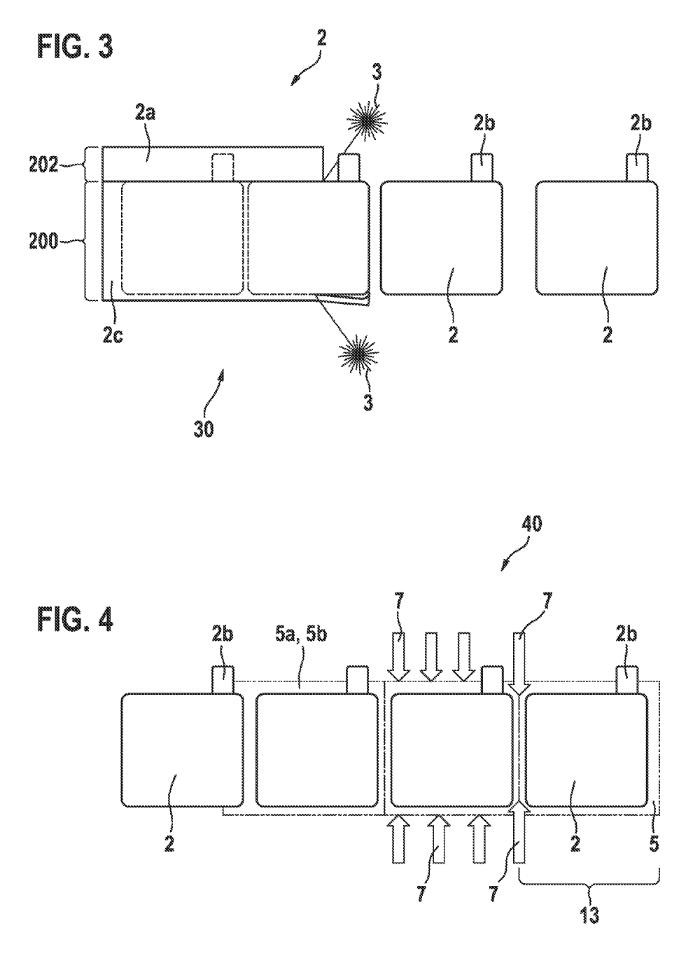

In a third step 30, which is illustrated in detail in FIG. 3, the, in particular strip-like, second electrode foil 2a and, respectively, the second electrode 2 are trimmed on all sides. As an alternative, the second electrode 2 is not trimmed on all sides, but rather only on three sides for example. At least one second contact lug 2b by means of which electrical contact can be made with the second electrode 2 is left standing on a first side from which contact can be made with the second electrode 2 in the finished battery cell. In FIG. 3, the second electrode foil 2a is coated with a second active material 2c in a first region 200 of the second electrode foil 2a and is free of the second active material 2c in a second region 202 of the second electrode foil 2a. Only the second contact lugs 2b remain standing from the uncoated second region 202 of the second electrode foil 2a after the trimming operation. The second electrode foil 2a is trimmed, for example, by means of a laser 3.

In a fourth step 40, which is illustrated in detail in FIG. 4, the second electrode 2 is inserted between two, in particular strip-like, separator films 5a, 5b, so that one separator film 5a is arranged beneath the second electrode 2 and one separator film 5b is arranged above the second electrode 2. The separator films 5a, 5b are illustrated in a virtually transparent manner in FIG. 4. Subsequently, the two separator films 5a, 5b are connected to one another in regions which project beyond the second electrode 2 on all sides, so that a first stack arrangement 13 is produced. As an alternative, the two separator films 5a, 5b are at least partially connected to one another in regions which project beyond the second electrode 2. The separator film 5a, 5b comprises, for example, a polyethylene and/or a polypropylene. The separator films 5a, 5b are connected, for example, by lamination 7 at the points indicated by arrows in FIG. 4 by way of example. The lamination 7 can also be performed at further points, not indicated in FIG. 4. As an alternative, the separator films 5a, 5b are connected to one another by means of thermal contact welding or adhesive bonding.

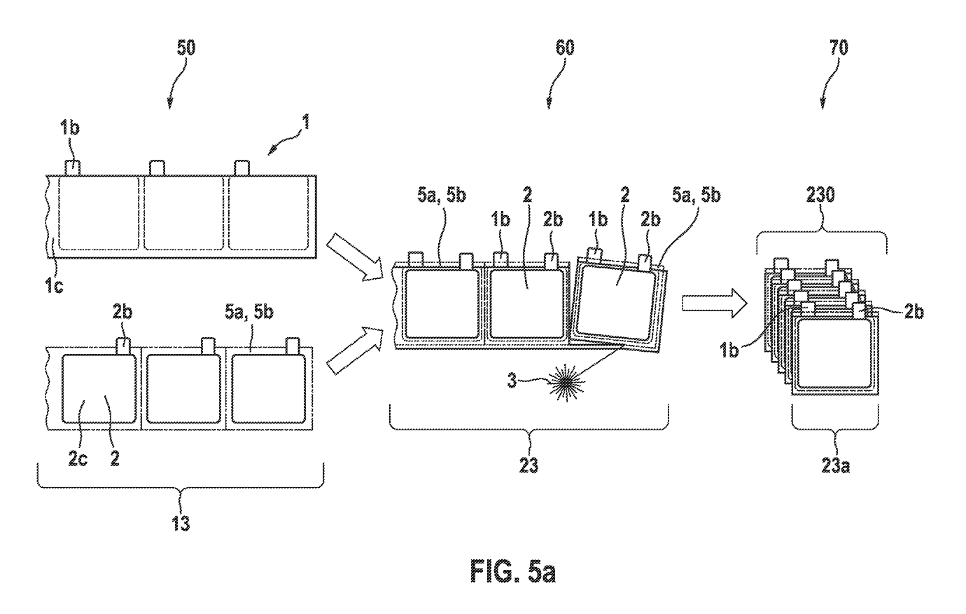

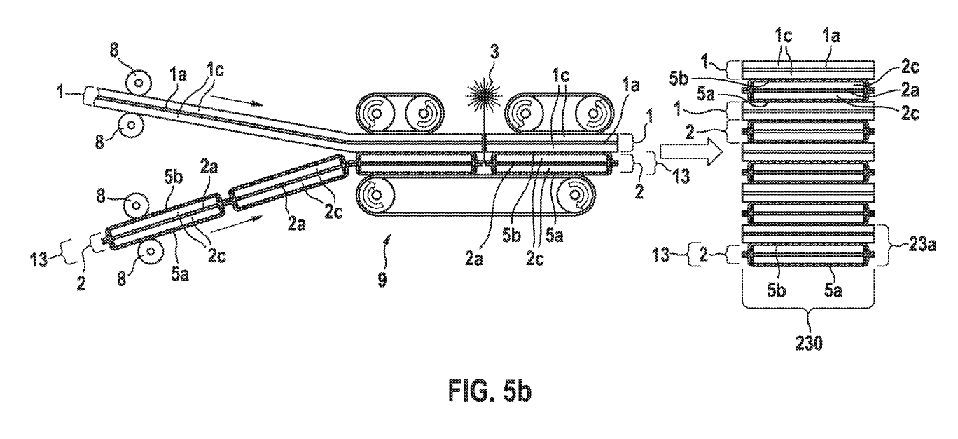

A fifth, a sixth and a seventh step are illustrated in detail in a plan view in FIG. 5a and in a side view in FIG. 5b.

In the fifth step 50, the, in particular, strip-like, first electrode 1 and the first stack arrangement 13 are placed one above the other, so that an electrode composite 23 is produced, as illustrated in FIG. 5a. In this case, the first contact lug 1b of the first electrode 1 and the second contact lug 2b of the second electrode 2 are arranged offset in relation to one another. In the sixth step 60, the, in particular strip-like, first electrode 1 and the, in particular strip-like, separator films 5a, 5b of the electrode composite 23 are trimmed in the regions next to the second electrode 2 and/or respectively between two second electrodes 2, so that individual units of electrode composites 23a are produced in each case. The trimming operation is performed, for example, by means of a laser. As an alternative, the trimming operation is performed by means of a blade or by means of a stamping tool. In the seventh step 70, the individual units of the electrode composites 23a are assembled to form a stacked electrode composite 230. In this case, the individual electrode composites 23a are respectively stacked one on the other with the same orientation, so that a first stack arrangement 13 adjoins each first electrode 1.

FIG. 5b shows a side view of the steps described in relation to FIG. 5a. Said FIG. 5b illustrates how the first electrode 1, which up until now has been trimmed only on a first side, is fed to an apparatus 9 for producing an electrode composite 23 in the fifth step by means of a feeding aid 8, for example rollers. At the same time, the first stack arrangement 13 is likewise fed to the apparatus 9 for producing an electrode composite 23 by means of a further feeding aid 8, for example rollers. The first electrode 1 and the first stack arrangement 13 are stacked one on the other in said apparatus. In FIGS. 5a, 5b, the first electrode 1 is stacked onto the first stack arrangement 13. As an alternative, the first stack arrangement 13 is stacked onto the first electrode 1. In the sixth step 60, the, in particular strip-like, first electrode 1 and the, in particular strip-like, separator films 5a, 5b of the electrode composite 23 are trimmed in regions next to the second electrode 2 and/or respectively between two second electrodes 2, so that individual units of electrode composites 23a are produced in each case. The trimming operation is performed, for example, by means of a laser 3. As an alternative, the trimming operation is performed by means of a blade or by means of a stamping tool. The seventh step has already been described in the explanations relating to FIG. 5a.

The order of steps 10-70 can differ from the order illustrated here. Steps 10, 20 and 30 are preferably performed in said order. As an alternative, steps 10, 20 and 30 can be interchanged, for example, in any desired order. Steps 50 and 60 are preferably performed in said order. As an alternative, steps 50 and 60 proceed, for example, in reverse order.

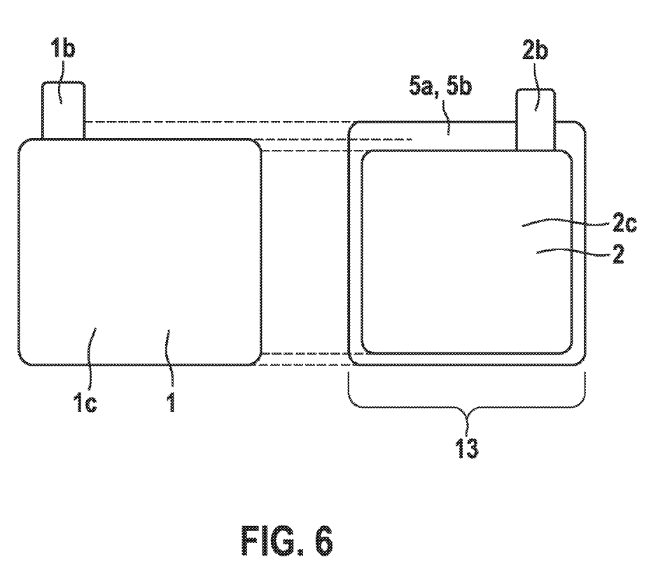

FIG. 6 illustrates a first electrode 1 having a first contact lug 1b and a first stack arrangement 13 of a battery cell which have been produced using the method according to the invention in accordance with FIGS. 1-5. The first stack arrangement 13 comprises a second electrode 2 which is inserted between two separator films 5a, 5b. Furthermore, the second electrode 2 comprises a second contact lug 2b. The first electrode 1 is, for example, an anode and the first electrode foil la, which is covered by a first active material 1c in FIG. 6 and is therefore not visible, comprises, for example, a copper foil. The first active material lc comprises, for example, a graphite, in particular a natural graphite or a synthetic graphite, a carbon, a silicon or a composite of these substances. The second electrode 2 is, for example, a cathode and the second electrode foil 2a, which is covered by a second active material 2c in FIG. 6 and is therefore not visible, comprises, for example, an aluminum foil which is coated, in particular, with a lithium transition-metal oxide, for example with LiNiₓMn_{y}Co_{z}O₂, or an over-lithiated lithium transition-metal oxide, for example with LiNiₓMn_{y}Co_{z}O₂*Li₂MnO₃, or another suitable lithium compound which comprises, for example, lithium ions, other metal ions and oxygen, or a lithium transition-metal phosphate, such as LiFePO₄ for example.

The first electrode 1 and the second electrode 2 are not coated with active material 1c, 2c in the region of the first contact lug 1b of the first electrode 1 and of the second contact lug 2b of the second electrode 2. The separator films 5a, 5b have larger dimensions on the side on which the first contact lug 1b of the first electrode 1 and the second contact lug 2b of the second electrode 2 are situated than the first electrode 1 and than the second electrode 2. The first electrode 1 has larger dimensions than the second electrode 2 on all sides. In the finished battery cell, the first electrode 1 and the first stack arrangement 13 are present in the form of a stacked electrode composite 23a. A corresponding battery cell, in particular a corresponding pouch cell, is used, for example, in motor vehicles which are configured as hybrid or electric vehicles.

1. A method for producing an electrode composite (23) of a battery cell, comprising at least one first electrode (1) having a first electrode foil (la), at least one second electrode (2) and at least one separator film (5a, 5b), the method comprising trimming the first electrode foil (1a) on a first side from which contact can be made with the first electrode foil (1a) in the finished battery cell, so that at least one first contact lug (1b) is exposed.

2. The method as claimed in claim 1, characterized in that the first electrode foil (1a) is trimmed on the first side, before the first electrode (1), the separator films (5) and the second electrode (2) are stacked one on the other.

3. The method as claimed in claim 1, characterized in that, for the purpose of producing the first electrode (1), the first electrode foil (1a) is coated with a first active material (1c), and in that, for the purpose of producing the second electrode (2), a second electrode foil (2a) is coated with a second active material (2c).

4. The method as claimed in claim 3, characterized in that the second electrode foil (2a) is trimmed so that the second electrode (2) is exposed by way of the second contact lug (2b).

5. The method as claimed in claim 3, characterized in that the second electrode (2) is inserted between two separator films (5a, 5b) and the two separator films (5a, 5b) are connected to one another at least partially in regions which project beyond the second electrode (2) so that a first stack arrangement (13) is produced.

6. The method as claimed in claim 5, characterized in that the separator films (5a, 5b) are connected by lamination, thermal contact welding, adhesive bonding or perforation.

7. The method as claimed in claim 5, characterized in that the first electrode foil (1a) and the first stack arrangement (13) are placed one above the other in such a way that the first contact lug (1b) of the first electrode (1) and the second contact lug (2b) of the second electrode (2) are offset in relation to one another, so that an electrode composite (23) is produced.

8. The method as claimed in claim 7, characterized in that the first electrode foil (1a) and the separator films (5a, 5b) of the electrode composite (23) are trimmed in regions next to the second electrode (2) and/or respectively between two second electrodes (2).

9. The method as claimed in claim 1, characterized in that the electrode foils (la, 2a) and/or the separator films (5a, 5b) are trimmed by means of a laser (3), a blade or a stamping tool.

10. A battery cell, comprising a stacked electrode composite (23a) produced in accordance with a method as claimed in claim 1, characterized in that the first electrode (1) is an anode, and in that the second electrode (2) is a cathode.

11. The battery cell as claimed in claim 10, characterized in that the separator films (5a, 5b) have larger dimensions than the first electrode (1) and larger dimensions than the second electrode (2) on a side on which the first contact lug (1b) of the first electrode (1) and/or the second contact lug (2b) of the second electrode (2) are/is situated.

12. The battery cell as claimed in claim 10, characterized in that the first electrode (1) has larger dimensions than the second electrode (2).

13. The battery cell as claimed in claim 10, characterized in that the separator film (5a, 5b) comprises a polyethylene and/or a polypropylene.

14. A battery comprising at least one battery cell as claimed in claim 10.

15. The method as claimed in claim 1, wherein the battery cell is a lithium-ion battery cell, wherein the first electrode foil is strip-like, and wherein the separator film is strip-like.

16. The method as claimed in claim 1, characterized in that the first electrode foil (1a) is trimmed exclusively on the first side before the first electrode (1), the separator films (5) and the second electrode (2) are stacked one on the other.

17. The method as claimed in claim 1, characterized in that, for the purpose of producing the first electrode (1), the first electrode foil (1a) is coated on both sides with a first active material (1c), leaving free the region of the first contact lug (1b) of the first electrode (1), and in that, for the purpose of producing the second electrode (2), a strip-like second electrode foil (2a) is coated on both sides, with a second active material (2c), leaving free the region of a second contact lug (2b) of the second electrode (2).

18. The method as claimed in claim 3, characterized in that the second electrode foil (2a) is trimmed on all sides before the first electrode (1), the separator film (5a, 5b) and the second electrode (2) are stacked one on the other, so that the second electrode (2) is exposed by way of the second contact lug (2b).

19. The method as claimed in claim 3, characterized in that the second electrode (2) is inserted between two separator films (5a, 5b) and the two separator films (5a, 5b) are connected to one another at least partially in regions which project beyond the second electrode (2) on all sides, so that a first stack arrangement (13) is produced.

20. A pouch cell, comprising a stacked electrode composite (23a) produced in accordance with a method as claimed in claim 1, characterized in that the first electrode (1) is an anode, and the first electrode foil (1a) comprises a copper foil, and in that the second electrode (2) is a cathode, and the second electrode foil (2a) comprises an aluminum foil.
